(19) United States
(12) Patent Application Publication
(10) Pub. No.: US 2023/0282239 A1
(43) Pub. Date: Sep. 7, 2023

(54) OBJECT ANIMATION WITH USER-PROVIDED AUDIO SUPPLEMENTATION

(71) Applicant: Turbo Blaster Unlimited, LLC, Seattle, WA (US)

(72) Inventors: Jeremy Hardt Rudo, Seattle, WA (US); Tovi Jordan Newman, Seattle, WA (US); Patrick Wallace Brooks, Seattle, WA (US)

(21) Appl. No.: 18/116,782

(22) Filed: Mar. 2, 2023

Related U.S. Application Data
(60) Provisional application No. 63/316,711, filed on Mar. 4, 2022.

(51) Int. Cl. G11B 27/02

(52) U.S. Cl. CPC G11B 27/02

(57) ABSTRACT

Systems, methods, and techniques to generate a video based, at least in part, on an image and an audio track. In one example, a system obtains an image depicting an object and an audio track, and generates a video depicting one or more features of the object animated based on the audio track.

### CLAIM OF PRIORITY

This application claims the benefit of U.S. Provisional Application No. 63/316,711 titled “OBJECT ANIMATION WITH USER-PROVIDED AUDIO SUPPLEMENTATION,” filed Mar. 4, 2022, the entire contents of which is incorporated herein by reference.

### BACKGROUND

Animation of objects, such as pets or other animals, presents numerous challenges that often makes the results less than ideal. As an example, movies, video games, and other examples of content often make attempts to anthropomorphize objects for the purpose of entertainment. However, differences between the objects and their human counterparts can create unnatural results. Not only are movements difficult to mimic, but audio creates additional challenges. Audio, for example, can become unnatural, unrealistic, and/or otherwise less than ideal when anthropomorphizing audio processing techniques are applied. Addressing such issues often requires significant resources, such as computational resources and additional human effort.

### BRIEF DESCRIPTION OF THE DRAWINGS

Various techniques will be described with reference to the drawings, in which:

FIG. 1 illustrates an example of an environment in which various embodiments can be practiced;

FIG. 2 illustrates an example of a process to generate an electronic greeting card, in accordance with at least one embodiment;

FIG. 3 illustrates an example of a process to generate audio content, in accordance with at least one embodiment;

FIG. 4 illustrates an example of the backend process to obtain audio segments, in accordance with at least one embodiment;

FIG. 5 illustrates an example page of a user interface of a client device, in accordance with at least one embodiment;

FIG. 6 illustrates an example page of the user interface of FIG. 5 to select an image, in accordance with at least one embodiment;

FIG. 7 is a screenshot of the user interface where the device obtains a cropping of the selected image for the video based on user interaction, in accordance with at least one embodiment;

FIG. 8 is a screenshot of the user selecting features in the facial expression of the image of a dog which frame the animation of the visual, in accordance with at least one embodiment;

FIG. 9 is a screenshot of the user configuring the color tone of the mouth of the image of the dog, in accordance with at least one embodiment;

FIG. 10 illustrates an example of a client running the application where the application obtains a selection of the backing track for the greeting card, in accordance with at least one embodiment.;

FIG. 11 illustrates an example of a client running the application where the device initiates the recording of a pet's voice or the selection of uploading the audio from local store, in accordance with at least one embodiment;

FIG. 12 illustrates an example of a client running the application where the device processes the audio recording of barks in accordance with at least one embodiment;

FIG. 13 illustrates an example of a client running the application to obtain user input regarding the style of pet sound in the finalized greeting card song, in accordance with at least one embodiment;

FIG. 14 illustrates an example of a client device obtaining a selection of segments of the barks in the audio recording to prepare for integration into the musical greeting card, in accordance with at least one embodiment;

FIG. 15 and FIGS. 15A-15B illustrate an example of a client running the application requiring user input to confirm the completion of the audio composition of the greeting card, in accordance with at least one embodiment;

FIG. 16 and FIGS. 16A-16D illustrate an example of animation of the dog to make the dog appear to be singing, in accordance with an embodiment; and

FIG. 17 illustrates a computing device that may be used, in accordance with at least one embodiment.

### DETAILED DESCRIPTION

Techniques and systems described below relate to an application that animates objects, such as by anthropomorphizing the objects to perform in a manner mimicking humans. In one example, a system animates physical features of an animal and modulates a vocal recording of an animal to create a personalized digital greeting card using backing tracks that match the tonal features of pet sounds, thereby enabling the dog to appear to move and sing in accordance with the song. In one example, the user either records their pet barking or meowing or uploads a video or audio file that contains barks or meows. The application then automatically sections the numerous barks or meows into individual barks or meows. The user then selects which individual barks or meows they want to use for their song. Each bark or meow tends to have a natural semblance to a particular musical note. The app then modulates (changes the pitch) of the bark or meow to follow the melody of the song. Techniques described herein avoid problems with audio such as when the pitch of the pet voice changes too much during modulation of the bark or meow and, consequently, becomes unnatural sounding. Additionally, techniques described herein allow additional advantages such as avoiding drastic changes in pet voices that cause humans to no longer recognize the identity of the user's pet in the recording.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Techniques described and suggested in the present disclosure improve the field of computer-aided animation in various ways, such as by: enabling realistic anthropomorphic animations of objects without requiring large amounts of compute capacity; enabling realistic anthropomorphic animations of objects with realistic audio that mimics the human voice; enabling user-created animations that allow for greater flexibility for the user while maintaining realistic audio and video; and enabling user-created content that utilizes objects personal to the user and that includes audio of those objects that are personal to the user.

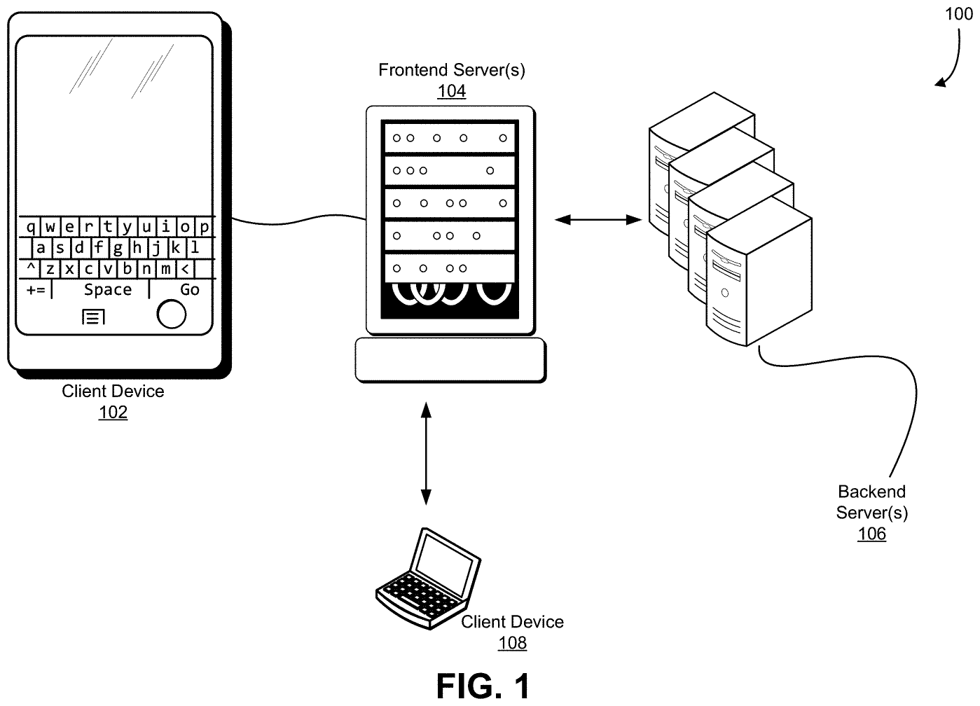

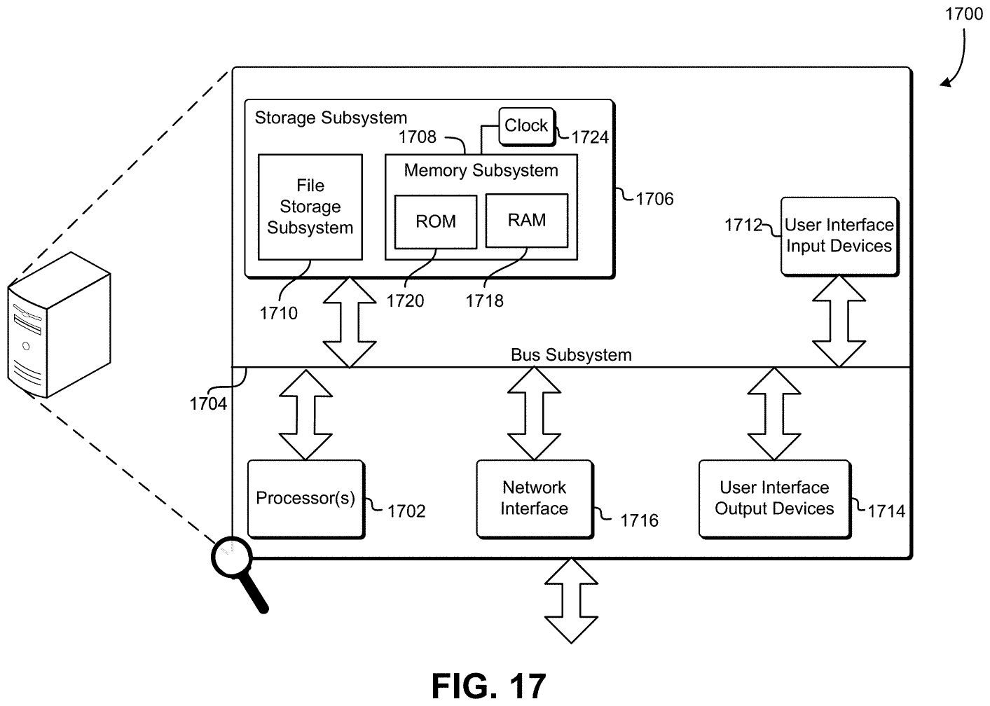

FIG. 1 shows an example of an environment 100 in which embodiments of the present disclosure can be implemented. In this example, the environment 100 comprises a first client device 102, a set of frontend servers 104, a set of backend servers 106, and a second client device 108. The client device 102 may be a computer system such as described below in connection with FIG. 17. In one example, the client device 102 is a smartphone or a tablet computing device, although other form factors of a client device are considered as being within the scope of the present disclosure. The client device 102, in an example, is used by a user to interact with a graphical user interface to provide specifications of an electronic greeting card generated in accordance with the techniques described herein. The frontend server 104, in an embodiment, can be a server computer system with components such as described below in connection with FIG. 17. The frontend server 104, in an embodiment, handles HTTP requests from the device client 102 and stores, processes and delivers web resources based on the incoming traffic from the client and the availability of data from the backend servers 106. A frontend server 104 may route an upload media request from the client device 102 to the backend server 104 to store the audio recording of dog barking sounds. The frontend server 102 may relay the segmented audio clips of individual dog barks processed by the backend servers 106 to the client device 102. In another example, the server may transmit a completed digital greeting card from the backend server 106 to the second client device 108 as the final step in the communication flow. The backend servers 106, which may be implemented as a server in a private data center or a publicly hosted cloud server, executes the instructions to process media uploaded by the client device 102 though the frontend servers 104. The backend servers 106 may execute instructions contained in its local store which map segments of the uploaded audio recording to notes in a backing track. This backing track may be obtained in the local store of the backend servers. When the backend servers 106 completes the audio processing of the media uploaded to the servers, they may transmit the finished audio to the device client through the frontend servers 104.

In an embodiment, when the user on a client device shares a completed greeting card with another user, the request to share a digital greeting card is transmitted first through the front end server 104 and then the target client device 108. The target client device, as described below, in connection with FIG. 1 may be a computer system capable of executing machine instructions, such as described below in connection with FIG. 17. The target client device 108 has a processor which enables the device to execute instructions stored in its local storage that handles the incoming digital greeting card in the form of an email, social media platform, or text message. The client device may be a mobile telephone communication system, a desktop computer system, a laptop or a tablet computer system, such as described below in connection with FIG. 17. In an embodiment, sharing a digital greeting card comprises enabling the client device 108 to access content that has been generated in accordance with input of the client device 102. Enabling access may be accomplished in various ways in accordance with various embodiments, such as by transmitting an electronic message with a uniform resource location or other uniform resource identifier or other reference that the client device 108 can use to obtain the content. Other mechanisms include posting the content in accordance with an interactive multi-user system (e.g., a social media system). As another example, the frontend server 104 can provide the client device 102 with a URL or other reference that the client device 102 can transmit to the client device 108 through various mechanisms, such as SMS or an electronic mail message.

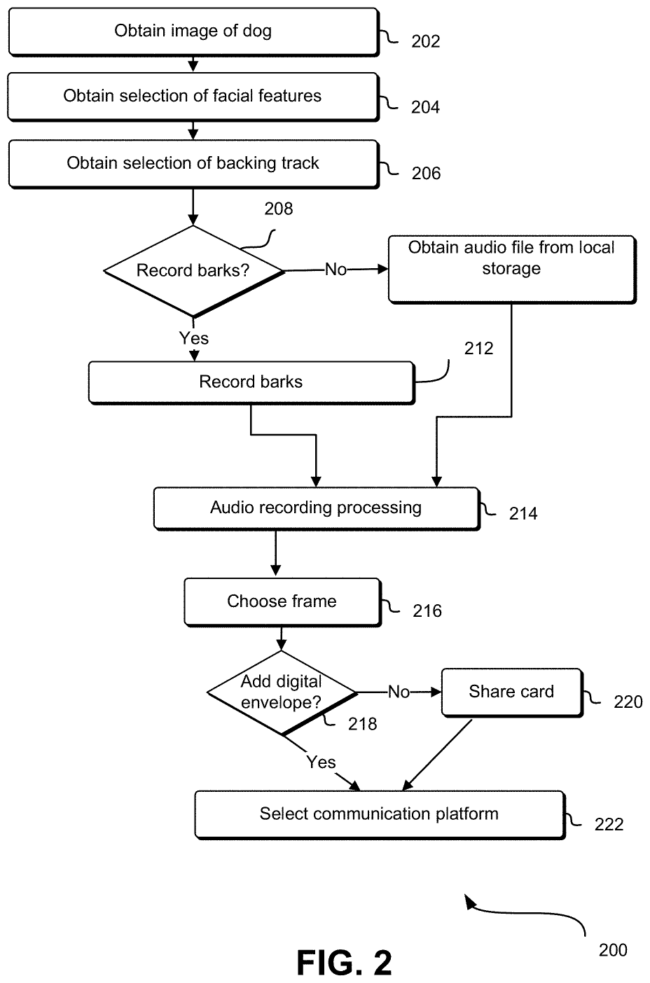

FIG. 2 shows an illustrative example of a process 200 to create an electronic greeting card in accordance with an embodiment. The process 200 can be performed by any suitable device, such as the client device 102 discussed above in connection with FIG. 1. In one example, operations described in connection with FIG. 2 are performed by another device in alternate embodiments, examples of which appear below. In at least one embodiment, some or all of process 200 (or any other processes described herein, or variations and/or combinations thereof) is performed under control of one or more computer systems configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in the form of a computer program comprising a plurality of computer-readable instructions executable by one or more processors. In at least one embodiment, a computer-readable storage medium is a non-transitory computer-readable medium. Some computer-readable instructions usable to perform process 200 are not stored solely using transitory signals (e.g., a propagating transient electric or electromagnetic transmission). A non-transitory computer-readable medium does not necessarily include non-transitory data storage circuitry (e.g., buffers, caches, and queues) within transceivers of transitory signals. In at least one embodiment, process 200 is performed at least in part on a computer system such as those described elsewhere in this disclosure.

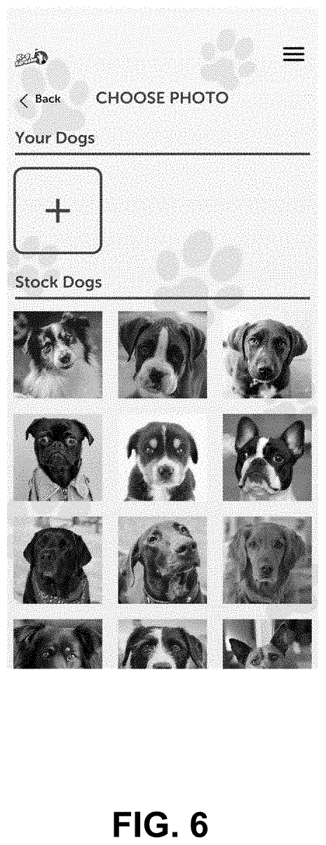

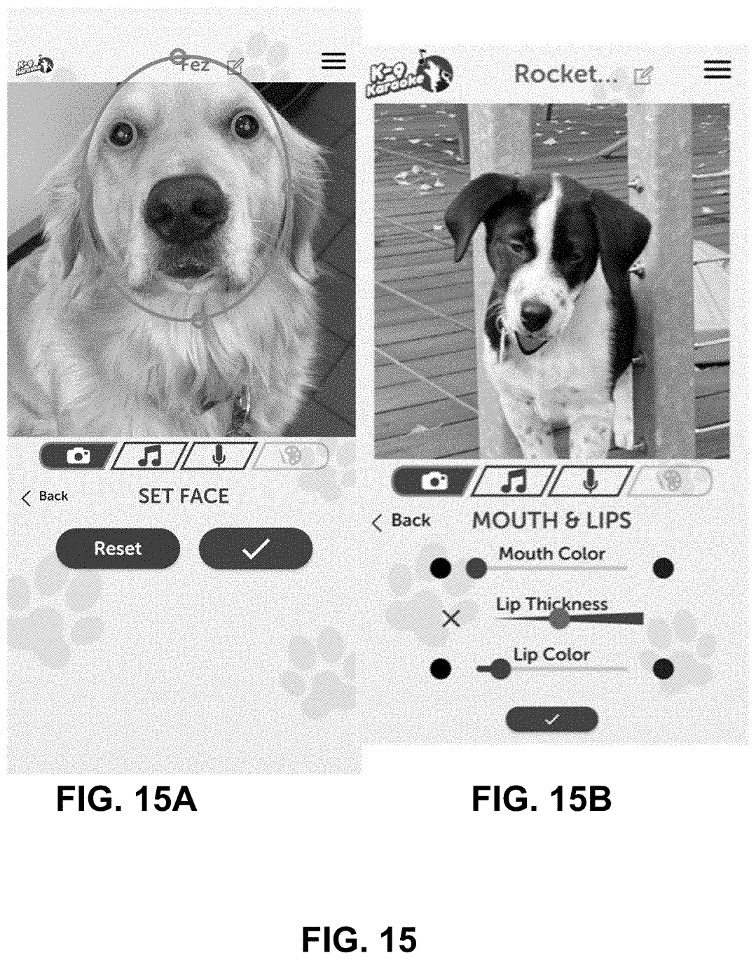

In an embodiment, the process 200 comprises obtaining 202 an image of a dog. While a dog is used for the purpose of illustration, it should be understood that the process 200 can be adapted to other objects, such as cats, other animals, other animate objects (e.g., robotic devices), and other objects, such as objects with features resembling the human face (e.g., automobiles) and other objects. The client device can obtain the image of a dog in various ways in accordance with various embodiments, an example of which is shown in FIG. 6. For instance, in one embodiment, the client device can utilize a camera of the client device to capture an image of the dog. As another example, the client device can, pursuant to user input, select a locally stored file of the dog (perhaps captured using the camera). As yet another example, the client device can select a file of the dog from a cloud based storage provider or other such service provider providing an application in connection with the process 200 is performed. The device obtains 204 identification of the facial features of the uploaded image of the dog through user input. For instance, in one embodiment, the user touches points on the screen showing an image of a dog where the eyes, mouth, chin, and ears of the image are located. Such user input can be guided through a graphical user interface, such as by overlaying images to allow the user to adjust the overlay to match points on the overlay to features of the dog. An example overlay is shown in FIG. 15. In another example, the device executes a neural network that recognizes certain features of the image such as face, nose, and mouth that obviates user input in the identification of facial features of the dog. In a further example, the neural network may identify the tail, hind legs, and ears of the dog as areas to animate in the video of the pet in the greeting card. In an embodiment, these features are registered by the device as points of animation in the creation of the digital greeting card. As an example, the mouth feature of the image is opened and closed in visual tandem with the pitch of the melody of the backing track in the creation of the video of the pet singing. In an embodiment, a neural network can be used to detect features of the dog and an overlay can be sized and/or positioned to match the detected features. A user, in this example, may adjust the size and/or position of the overlay to make any corrections or other adjustments.

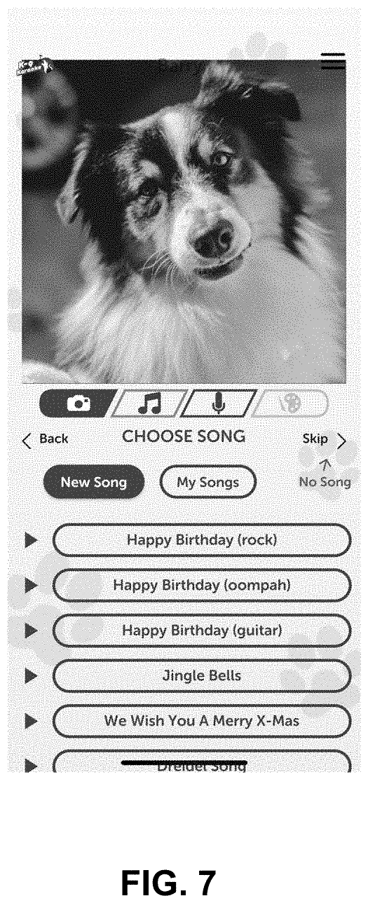

In an embodiment, the device obtains 206 selection of the backing track of the singing greeting card with input from the user. In one embodiment, the user picks from among a list of songs. The songs may be ones that are in the public domain and/or for which suitable rights have been obtained. In an example, the device obtains from the user a preference to choose a previously made song locally stored in the data store of the application. In another example, the user selects to skip a selection of a backing track to make a digital greeting card without a musical accompaniment. An example page of a user interface to enable selection of a backing track is shown in FIG. 7.

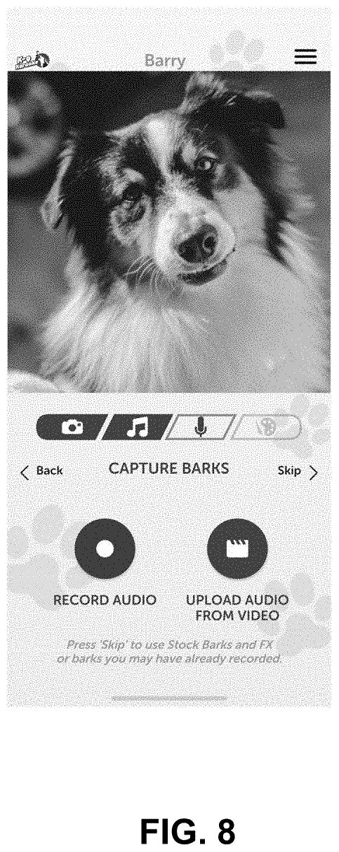

In an embodiment, the device obtains the user's selection of a preference to record or not record the sound of the barking of the dog. The user records 212 an audio clip of the barking sounds of the dog with the user starting and ending the microphone processing of signals. In another embodiment, the user elects to upload 210 an audio sample from a video of the dog stored in the local data storage. In another embodiment, the device presents the user with an option to mimic using the user's own voice or the voice of the user's dog and record audio of barks. In another example, the device allows for the recording of multiple pets in the creation of the audio clips for processing in the creation of a greeting card. Example user interface pages related to obtaining audio of the dog are shown in FIGS. 8-10.

In an embodiment, the device performing the process 200 processes 214 the audio recordings of the pet voices. In an example, the device executes instructions stored locally in memory that modulates the barking audio clip and segments the clip to identify individual barks in the recording. The device then maps the barking segments into notes in the melody of the selected backing track. In another example, the device uploads the audio recording of the barking sounds of the pet onto the backend server where the instructions to modulate the audio clip and segment the clip to identify individual barks are stored. In an embodiment, the backend servers perform the instructions to process the uploaded audio and transmits the media to the client application.

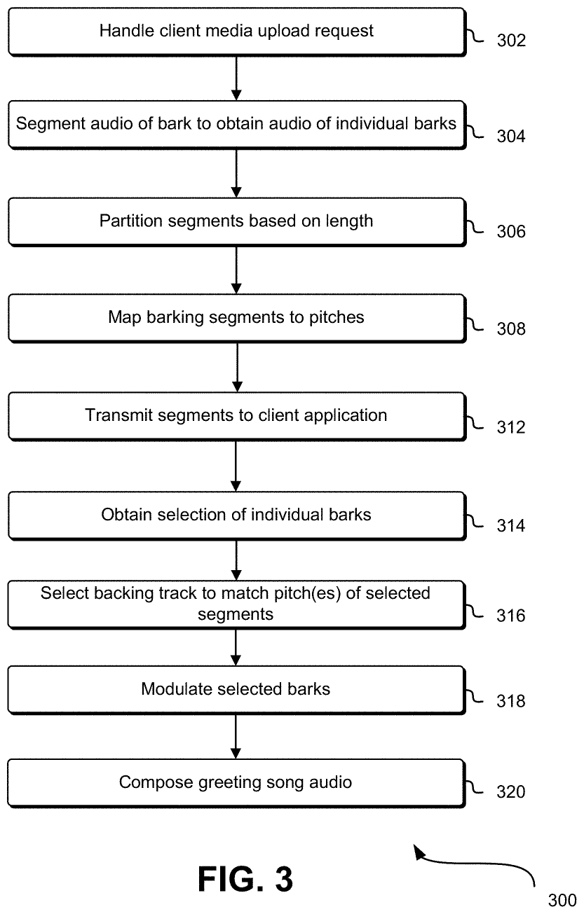

In an embodiment, the backend server processes the audio recording uploaded by the client device as illustrated in FIG. 3. In an example of the embodiment, the server is hosted in a public cloud and runs a JavaScript-based web framework to provide an endpoint for client devices to upload audio recordings of dogs. The server uses Python-based libraries to filter the audio input signals for windows (e.g., time intervals) where start and end times can be determined to define segments which are saved in the computing clusters of the cloud server. In an example of the embodiment, Kubernetes deployment systems are orchestrated to efficiently execute the digital signal processing instructions that identify the beginnings and endings of the segments of individual barks of the uploaded audio recording.

Turning back to FIG. 2, in an embodiment, the device prompts 216 the user for selection of an art frame to wrap the greeting card. In an example, the user interface of the device presents a series of visually appealing borders for the user to pick among. In an example the user uses the touch interface to rotate through the choices and select a frame that matches the aesthetics of the image of the pet.

In an embodiment, the device prompts 218 the user for a preference on whether to add an envelope as a step in the preparation of the digital greeting card for transmission. The user selects among two user interface elements delineating two paths of user flow where one path incorporates additional instructions to add a visual envelope to the digital representation of the greeting card and another avoids the addition of the visual envelope in the sharing of the digital greeting card to a target device.

In an embodiment, the device prompts 222 the user for a selection of the method of transmission of the completed greeting card among interactive multi-user online systems (e.g., social media platforms), email, and other digital communication channels. In an example, the user may skip the selection of a medium for the sharing of the greeting card and choose to store the completed greeting card in local data store.

Other operations may also be performed in the process 200 and variations thereof. For instance, in an embodiment, the process includes obtaining audio from a user, which may be a custom message that can be added to the electronic greeting card, such as to play before the video of the dog or other object singing the song that has been selected. In some embodiments, the user has an option of having only a human voice recording message without a song. In some embodiments, the application that provides the interface pages enforces a requirement that the electronic card being created includes a song, a personal message, or a combination of the two.

Referring to FIG. 3, the figure shows an illustrative example process 300 for generating audio in accordance with an embodiment. In at least one embodiment, some or all of process 300 (or any other processes described herein, or variations and/or combinations thereof) is performed under control of one or more computer systems configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, at least some computer-readable instructions usable to perform process 300 are not stored solely using transitory signals (e.g., a propagating transient electric or electromagnetic transmission). In at least one embodiment, a non-transitory computer-readable medium does not necessarily include non-transitory data storage circuitry (e.g., buffers, caches, and queues) within transceivers of transitory signals. In at least one embodiment, process 300 is performed at least in part on a computer system such as those described elsewhere in this disclosure.

In an embodiment, the process 300 includes handling 302 a media upload request. The media upload request can be, for example, an application programming interface (API) call to a server performing the process 300, where the API call comprises sufficient data to cause the server to perform further operations in the process 300. The media upload request, in an embodiment, is a mechanism by which audio of a barking dog is provided to the device performing the process 300. The request may be initiated by an application with a graphical user interface, such as described below.

The audio of the barking dog, once obtained by the device performing the process 300, in an embodiment, segments 304 audio of the bark to obtain audio of individual barks, such as described in more detail below. Having obtained 304 the segments, in an embodiment, the device performing the process 300 partitions the segments based on length to enable different length barks to be used for different length musical notes to enhance the song audio that will be created. The segments can be partitioned in various ways in accordance with various embodiments. In one example, the barks are partitioned into three categories: short, medium, and long where all medium-length barks are longer than each of the individual short barks and where all long barks are longer than each of the individual medium-length barks. In one embodiment, the length of each bark is recorded and the partitions are created by distributing the barks among the partitions based on their length. In this example, the partitions may have an approximately equal number of barks in each partition (e.g., the number of barks in each partition may differ by at most one). In other examples, the barks are clustered based on length. This can be performed, for instance, by calculating the shortest, longest, and a median-length bark. Such clustering can result in different size partitions, but greater similarity in bark length within the clusters. With clustering, some clusters may have zero barks, depending on the behavior of the dog. In such an instance, a user may be able to select a substitute bark, such as a pre-recorded bark from the same or similar breed and/or by performing an audio transformation to transform the length of a bark to provide substitutes to provide additional barks for clusters.

Having partitioned the barks, in an embodiment, the system performing the process 300 maps the segments to musical pitches. The system, for instance, may use a pitch detection algorithm to analyze the segment to map the segment to a pitch. The system may use an average magnitude difference function (AMDF), average squared mean difference function (ASMDF), or other autocorrelation algorithm to determine a pitch in the time domain. The system may use one or more algorithms to analyze the segment in the frequency domain. Example algorithms that can be used are harmonic product spectrum, cepstral analysis, and maximum likelihood algorithms to match information from the frequency domain using pre-defined frequency maps. In one example, a dominant frequency of the bark in a segment and the dominant frequency can be mapped to the nearest frequency of notes on a musical scale. As an example using a heptatonic scale, if the segment had a dominant frequency of 430 Hz (between A4 at 440 Hz and A4-flat at 415.3 Hz), the segment would be mapped to the note A4 instead of A4-flat. Note that, while illustrated as being performed as a step immediately after partitioning the segments, mapping 308 of the barking segments can be performed at other times. Generally, for all processes described herein, operations can be performed in any order unless doing so would be contradictory (e.g., the input of one operation is dependent on the output of another operation). For instance, mapping of barks to notes can be performed before segmentation and the maps can be later associated with segments based on the time at which the barks occur.

As illustrated in FIG. 3, in an embodiment, the process 300 includes transmitting 312 the segments to the client application (i.e., to a device running the client application). Note, however, that other ways of indicating to the client application the segments are considered as being within the scope of the present disclosure. For instance, in embodiments where the device running the client application recorded the audio with the barks, a server performing the process 300 can send timestamps or other indicators (e.g., time offsets from a reference point in time in the recording) to define the segments. The device running the client application can segment the audio itself based on these indications sent by the server. In this manner, less bandwidth is used in the process of generating an electronic greeting card.

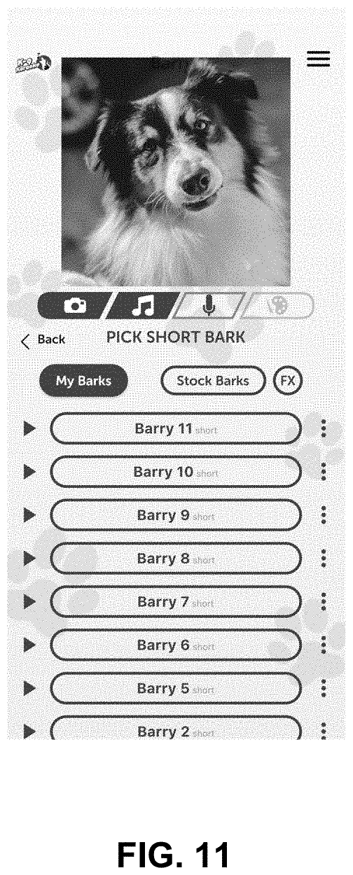

In an embodiment, a user with a device running the client application can, via a graphical user interface such as shown in FIG. 11, can listen to the segments and select which segments to use for a song. This allows the user to select the barks he or she thinks are best and to disregard segments where automated processing may have not segmented and/or partitioned correctly. In some embodiments, a user can select from each partition, with a different screen for selection among each partition. For instance, a user can select a short bark, a medium-length bark, and a long bark. Selections of barks can be transmitted to a server performing the process 300 and, accordingly, the server or other device can obtain 314 selection of the individual barks. In an embodiment, the device performing the process 300 creates an index (e.g., enumeration) of the individual segments and selection of the segments by the user causes the client device to send information that enables the server to determine which segments were selected.

Having obtained selection of the barks by the user, in an embodiment, the system performing the process 300 selects a backing track to match the pitch(es) of the selected segments. In an embodiment, multiple recordings of the same song are stored where each recording is performed in a different key. As one example, the song can be recorded in A major or minor, A-sharp major or minor, B major or minor, C major or minor, C-sharp major or minor, D major or minor, D-sharp major or minor, E major or minor, F major or minor, F-sharp major or minor, G major or minor, and G-sharp major or minor. Thus, in this example, the song can be recorded so that each recording is the same melody, but shifted in pitch. While this example covers shifts matching notes of a chromatic scale, different numbers of recordings in different keys can be used. In an embodiment, selecting a backing track is performed to minimize a metric measuring the amount by which a bark has to be modulated to match the notes of the song. This can be done in various ways. For instance, in one example, a melody of a song is used to create a histogram that counts the number of times each note is played. In this example, notes differing by an octave can be considered the same note. The recordings of the song can be indexed by the most frequently occurring note. For instance, if the most frequently occurring note in the melody of a recording of a song in a key song is C-sharp, that recording can be marked as C-sharp so that, if a bark is matched to C-sharp, that recording will be used as a backing track. If two or more notes are tied for most frequently occurring in a recording of a song in a key, a selection can be made as how to map the recording to a pitch. For instance, in a histogram of notes that occur in a recording of a song, the song can be mapped to the pitch closest to the center of mass of the histogram (e.g., the mean or median pitch of the song). Note that only one recording of a song need be analyzed because the remaining recordings can be mapped to pitches according to their distance from the pitch to which the one recording was mapped. For instance, if a recording of a song was mapped to B, the recording of the same song that is one half step higher would be mapped to C.

In an embodiment, the process 300 includes modulating 318 the selected segments to match musical notes that appear in the selected song and combining audio of the segments with audio of a backing track such that individual segments occur in time with their corresponding notes and times in a melody (and/or harmony) of the song. In an example, modulation of the selected segments may comprise changing the pitch of the segments to match corresponding notes in the song. Because a single segment may be modulated to match multiple different pitches, in one example, new segments are generated for each note to be used in the song.

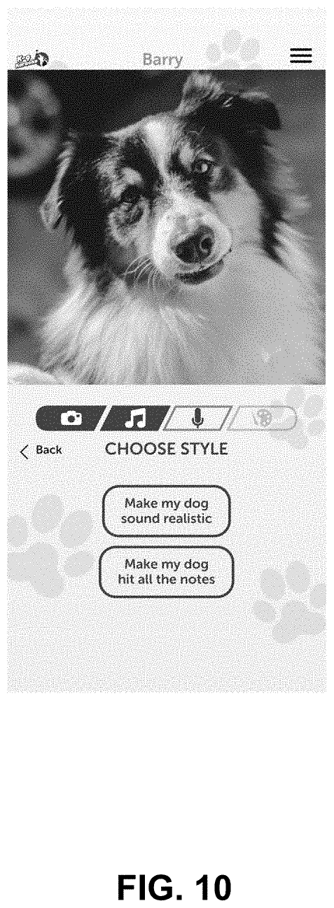

As illustrated in the example of FIG. 10, a user may provide input into how notes are modulated. In this specific example, the user can select whether the dog is to sound realistic (e.g., sometimes or all the time close to, but off pitch) or whether the dog is to hit all the notes. In the former case, modulation may not occur for a segment (e.g., if the segment maps to a note that occurs in the song, the segment may not be modulated to that note) or may occur so that the dominant frequency of the segment is close to, but not exactly, the pitch of the note of the song. In the latter case, modulation may occur to cause the dominant pitch of the segment to be exactly the frequency of a note of a song. Note that different barks can be modulated to match different pitches, the same bark can be modulated to match different pitches, different barks can be modulated to match the same pitch, and other variations can occur to provide variety in how the dog in the electronic greeting card sings different notes. In one example, results of modulation to match the same note are done differently (e.g., to have barks with different pitches matching the same pitch) to provide variety in how the dog in the electronic greeting card hits a note that occurs in multiple places in a song. How the match occurs, as noted, may depend on user settings on how accurate the dog's pitch is to match the pitches of the song. Note that user selection of how the dog will perform in the electronic greeting card can also occur with other options, such as according to a user-controllable slider that controls how much the dog's barks can vary from the pitches of the notes of the song.

Once the individual audio segments are modulated to match notes in the song, in an embodiment, the greeting song audio is composed 320 by the device performing the process 300. In an embodiment, the greeting song audio is a combination of the backing track and the modulated audio segments so that the modulated audio segments match the pitch and timing of the melody and/or harmony of the song. In one embodiment, musical notes of the song are marked with timestamps indicating when the notes are played (e.g., the beginning of the note or the midpoint of the note) and the segments are combined with the song according to the timestamps so that, when played together, the segments of the song bark the notes of the melody and/or harmony. Combination of the segments and the song can occur, for instance, by an additive combination of the waveforms. In one example, the segments of the barks have amplitude adjusted to be within a specified range so as to not be too loud or too soft relative to the backing track with which the segments are combined.

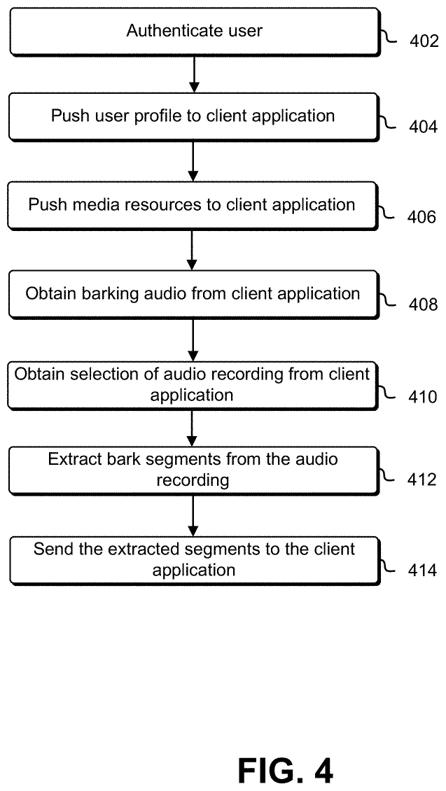

In FIG. 4, flowchart of a process 400 is presented illustrating an embodiment where the backend server processes the requests of the client applications. In at least one embodiment, some or all of process 400 (or any other processes described herein, or variations and/or combinations thereof) is performed under control of one or more computer systems configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, at least some computer-readable instructions usable to perform process 400 are not stored solely using transitory signals (e.g., a propagating transient electric or electromagnetic transmission). In at least one embodiment, a non-transitory computer-readable medium does not necessarily include non-transitory data storage circuitry (e.g., buffers, caches, and queues) within transceivers of transitory signals. In at least one embodiment, process 400 is performed at least in part on a computer system such as those described elsewhere in this disclosure.

In an embodiment, the system performing the process 400 authenticates the user, such as by verifying a username and password combination, or performing a process involving federated identity. For example, the system may use an established trust relationship with an identity provider to verify that the user authenticated with the identity provider, thus enabling the user to utilize an identity managed by another system to use an application. In one example, a user is able to authenticate with an interactive multi-user system (e.g., social network) to enable the user to post content to the system without additional authentication by the user.

In the example of FIG. 4, having authenticated the user, a profile can be pushed 404 to a client application. Pushing 404 the profile to the client application may include sending data to the client application (i.e., a device running the client application) to provide to the client application information about the user (e.g., information about a level of service the user has, information about past activity about the user, and other information). Additionally, media resources can also be pushed 406 to the client application to enable the user to use features of the client application. Such media resources may include song clips, audio clips of barks (or other sounds), pictures, videos and, generally, any media resources to enable use of features of the application.

In an embodiment, the process 400 includes obtaining 408 audio of barking from a client application, such as described above. Further, as illustrated in FIG. 4, the process 400 may include obtaining 410 a selection of an audio recording from the client application. Such a selection can be transmitted from the client application to the device performing the process 400, such as by transmission of an identifier of a backing track to be used. Such selection can be made, for instance, using a graphical user interface such as shown in FIG. 7.

Referring back to FIG. 4, the process 400 can include extracting 412 bark segments from an audio recording that was uploaded to the device performing the process 400. In one example, the system performs the process 400 by analyzing using a digital signal processing algorithm that identifies 414 the onset of the decay in the audio signals that demarcates individual barks from each other. The segmented barks are transmitted 414 to the client application, where they are combined with the backing track of the user's selection. This composition is combined 418 with the pre-song recording obtained from the user to complete the audio recording.

Note that, it is contemplated that the various interface control objects referred to in the present disclosure, such as buttons or radio buttons, refer to graphical control elements in a user interface that can be interacted with.

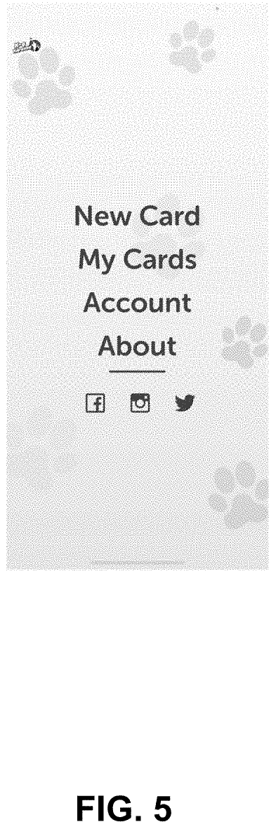

FIG. 5 shows an example of a page 502 from a graphical user interface to enable a user to create an electronic greeting card in accordance with various techniques described herein. In one example, the user interface is a graphical user interface of an application installed on a client device, such as the client device 102 described above. In other examples, graphical user interfaces to create electronic greeting cards can be provided in other ways, such as in the form of a web page or other interface provided by a server, such as the frontend server 104 described above in connection with FIG. 1. The graphical user interface presents options for a user to navigate the execution flow of the client device by selecting among buttons such as “New Card,” “My Cards,” “Account,” and “About.” The client device obtains from the user input a next step in the user experience and loads the proceeding page of the user interface. The graphical user interface may, upon the user's selection, initiate the composition of a digital greeting card. The “My Cards” button, in an embodiment, allows a user to access and view electronic greeting cards that he or she has begun and perhaps completed.

FIG. 6 illustrates an example page from a graphical user interface, such as the graphical user interface shown in FIG. 5. In an embodiment, selection of the “New Card” button in FIG. 5 causes the graphical user interface of FIG. 5 to transition to the page shown in FIG. 6. The page illustrated in FIG. 6 allows the selection of a photo for the digital representation of the dog in the greeting card. The page shown in FIG. 6, in an embodiment, allows a user to select a picture of a dog to use for an electronic greeting card. In this example, a “+” button allows a user to indicate that the user would like to provide its own picture. Selection of the “+” button allows the user, in an embodiment, to select between using a camera to obtain a picture and selecting a picture from a local data store.

FIG. 7 illustrates another page from a graphical user interface, such as the graphical user interface described above. The user interface page shown in FIG. 7 allows a user to select a song to be a backing track for an electronic greeting card. The page shown in FIG. 7 may appear, for example, as a result of a user selecting one of the stock dog photos provided with the application of the graphical user interface. By selecting the “New Song” button, the application allows the user to obtain a selection of a new backing track among a list of tracks downloaded onto the client application. The selection of a new song provides the basis over which the audio of the barks will be overlaid to form the greeting song and takes the user to the next screen in the user flow. In the application, the “My Songs” button, when pressed, causes a filter to be applied to the list of songs presented, thereby presenting the user interface with a list of previously selected greeting songs. In another example, the client device uses a locally stored library of backing songs that can provide the basis of the greeting card. This may be useful, in cases where the user wants a broader variety of tracks to choose from. The user can choose to skip the selection of a song and proceed with the creation of a greeting card with just the image of the dog and art frame. As implied in the figure, a user can select a “play” button next to a song name to listen to some or all of the song to aid in making a selection.

The client application illustrated in FIG. 8 shows a page of the user interface of FIG. 5 that enables a user to provide audio of their own dog. The page shown in FIG. 8 presents the user with a “Record Audio” button, which, when clicked, begins the recording using a microphone of the device running the user interface program and saves the recording for editing. Once the recording is complete, the top of the application presents the viewing of the photo of the dog along with the audio of the barks when the selection of the “Play” button is pressed by the user. The “ADD BARKS AND CONTINUE” button provides a link to the next page in the user interface flow. The “UPLOAD AUDIO FROM VIDEO” button allows the user to obtain the audio recording of barks from a user-accessible data store, such as a local storage device or a cloud storage account. Navigation to the page shown in FIG. 8 may occur as a result of selection and/or confirmation of selection of a backing track and/or selection of a microphone button in FIG. 7.

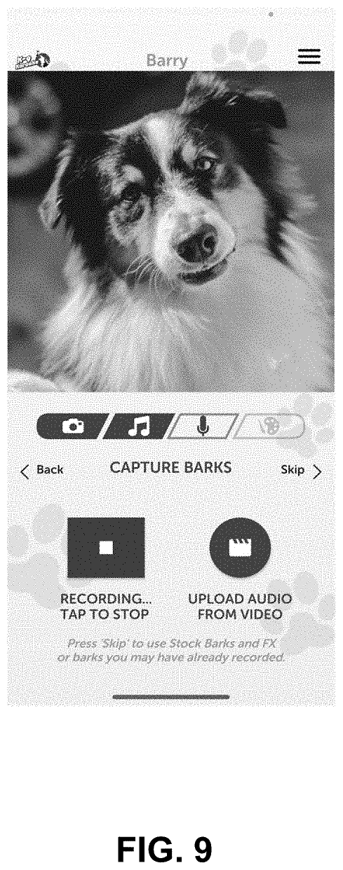

FIG. 9 illustrates a page of the user interface of FIG. 5 which may be the page of FIG. 8 after a user has selected the “record” button of FIG. 8. The page of the user interface shown in FIG. 9 allows the user to click on “RECORDING . . . TAP TO STOP,” which saves content of the audio up until when the button was pressed and stores it into local storage and/or uploads the recorded audio to a server. In some examples, selection of the “RECORDING . . . TAP TO STOP” button causes the audio file to be transcoded to another format (e.g., MP3) to conserve space. The user interface includes a Skip button that enables user to skip the selection of an audio recording and instead proceed with the creation of a greeting card with only visual elements such as the image of the dog and the art frame. In some examples, skipping the audio cause a server to generate the electronic greeting card using pre-recorded barks of the user's dog or another dog, or other such sounds. In another example of the embodiment, the device provides the creation of a purely visual greeting card with cats, horses, or humans, among other elements where facial expressions can be identified in the visual elements.

FIG. 10 illustrates a page from the user interface of FIG. 5 that enables a device running the user interface to obtain a selection from the user input against two buttons that indicate the preference for either a recording that emulates the natural sound of the dog bark or the tonal pitch of the key notes of the melody of the backing track in the greeting card. As noted above, other embodiments may have additional functionality to allow the user to indicate how close modulated pitches are to match the pitches of notes of the song. The device may, in one example, modulate the barks recording using digital signal processing algorithms stored in the local memory to achieve these sound effects. In another example, the device may upload the barks into the frontend server described above which then handles the processing of the audio according to the preferences indicated by the user input described above in connection with FIG. 10. In another example of the embodiment, the client device takes the user selection input and transmits the audio segments and the selection input to a publicly hosted cloud where a platform-as-a-service provider hosts the services that process the audio signals.

As shown in FIG. 10, a button with “Make my dog sound realistic” sets a parameter that causes selection of an alternative melody for the barking that is composed to reduce (relative to the original melody) the range of the notes played in the melody. This alternative melody, in an embodiment, is created by replacing notes at the top and or bottom of the range of the melody with other notes that are in harmony with the notes being replaced. In an embodiment, a note outside of a specified range (e.g., a range having an interval/width of minor sixth or octave) is replaced with another note of a chord of the song at the same time. For instance, if the song is on a C-major chord, a C note might be replaced with the next highest E note or the next highest G note in order to cause the melody line to still be recognizable, but within a narrower range (in this example replacing a note with a higher note, although notes can also be replaced with lower notes to bring down notes in the top portion of the original melody. In this manner, the melody line is more compact, thereby reducing the amount by which some barks are modulated and, therefore, making those notes sound more realistic.

Conversely, in an embodiment, the option to “Make my dog hit all the notes” sets a parameter to use the original melody of the song (or a variation thereof) and, generally, has a wider range of notes than the “Make my dog sound realistic” option. In this option, it is possible that the melody is more recognizable but, due to greater modulation from the original bark, some of the notes will sound less realistic unless additional processing is applied. In other embodiments, other parameters can be set. For example, in one embodiment, a parameter allows for modulation of the barks to be close to, but not exactly, the pitches of the notes of the song.

The page shown in FIG. 10, as an example, can appear as a result of a user selecting the “RECORDING . . . TAP TO STOP” button or the “skip” button illustrated in FIG. 9. Such modulation may, for example, place a dominant frequency of a bark closer to the pitch of the corresponding note, but further from the next closest adjacent pitch in the musical system used. Similarly, a “Make my dog hit all the notes” button sets a parameter such as described above or, in an alternative embodiment, that causes modulation of the barks to be closer to the pitches of the notes of the song, such as by having a dominant frequency of the barks match the frequencies of the notes exactly or within a small threshold. As discussed, finer grained control over how well results of modulation of bark sounds match actual pitches are also considered as being within the scope of the present disclosure. Also, as illustrated in FIG. 10 and other figures, a ribbon of buttons (camera, musical note symbol, microphone) allow for navigation to previous states of the graphical user interface to change selections and other parameters that have already been made while designing the electronic greeting card.

As illustrated in FIG. 11, a graphical user interface such as the graphical user interface of FIG. 5 can include a page that allows a user to select from barks that were identified through a process to segment audio, such as described above. FIG. 11, in particular, shows an example page that allows a user to play (via hitting a play symbol icon) barks that have been identified from an audio recording of barking and select one or more of the segments. FIG. 11 shows an example page for selecting from barks categorized as short. Similar pages may be presented to allow a user to select from barks categorized differently (e.g., as medium-length or long). Such pages may be presented by the graphical user interface after selection of a style as in FIG. 10 and related operations (e.g., transmission of audio to server, modulation by the server or another server, and transmission back to the client audio segments and/or information otherwise identifying the audio segments. In one example, the user makes the selection of a short bark, a medium bark, and a long bark that map to melodic elements of the backing song. The device allows 702 the option of picking stock barks from the local store which may be incorporated into the backing track to form the singing greeting card.

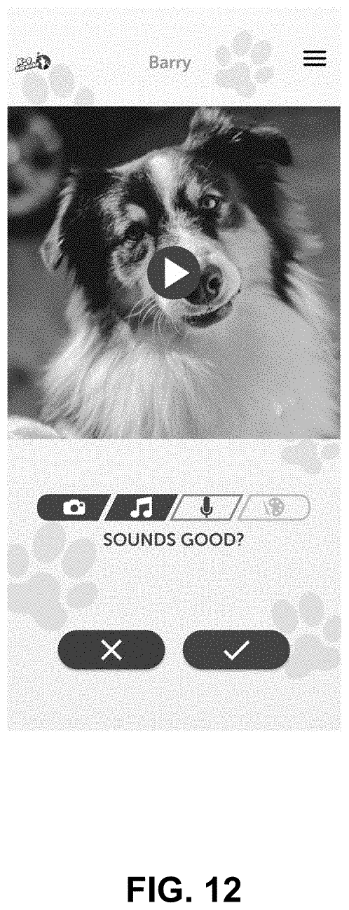

FIG. 12 illustrates an embodiment page of a graphical user interface such as noted above, where the device obtains a confirmation in a user interface dialogue that the audio recording of the barking and backing track meets the expectation of the end user. The confirmation is obtained through a true/false dialogue that requires input from the user via selection of corresponding user interface buttons (marked with an “X” and a check mark in the example page). The recording is presented as a playable media item and when the user selects the play button the musical composition is played using the device's speaker system. In one example of the embodiment, the image of the dog is presented to the user where the facial expressions of the image move in step with the melody of the musical composition to simulate a video recording of the original pet creating the audio recording.

The video provided in the example may be created in various ways in accordance with various embodiments. In one example, selection of the audio segments and selection of the dog (and perhaps the image of the dog too) are transmitted from a client device to a server and the server creates the video by combining the modulated audio segments, backing track, and animated image to generate a video file (e.g., mp4). In another example, the client device combines the modulated audio segments, backing track, and animated image to create a video file. In yet another example, some combinations are performed by a server and other combinations are performed by the client so that collectively the client and server create the video file. Creation of the animated image can be performed in various ways in accordance with various embodiments. For instance, in one example, key points of the image are identified to define regions in the image. The key points may correspond to, for example, vertices of polygonal regions that correspond to a body part (e.g., mouth, nose, ears, eyebrows, tail, etc.) The key points are used as parameters in an algorithm that warps the image according to the locations of the key points. The warping can be performed gradually (e.g., increasing and decreasing over time), in time with a backing track to, for example, create the impression that a dog in the image is opening and closing its mouth to bark the melody or harmony of the song, to move eyebrows, ears, etc., to give the impression that the image of the dog is animated and, in some embodiments, acts like a human.

In one embodiment, video with audio content is enabled by a client or server combining a barking melody with a backing track. The barking melody can comprise an audio file with modulated barks timed according to the song in the backing track so that, when played together, the barks follow the melody of the song recorded in the backing track. The barking track can have additional barks (e.g., additional parts in a bass-tenor-alto-soprano setting) that follow various musical lines of the song, although additional vocal parts may also be provided in additional barking tracks in some embodiments. For the video, in an embodiment, audio characteristics of the barking track is analyzed to create amplitudes of the barks at different times (e.g., the amplitude of the bark at each 60^{th} of a second or at some other interval, such as an interval that matches a refresh rate of a device to be used to display the content and/or a frame rate at which the content is to be displayed). In an embodiment, the device (e.g., client or server) converts audio of the bark melody to a wav file and sums groups of samples so that the samples can be used as animation instructions, stored as numbers in a list or array, where each number represents one of a number (e.g., sixty) different mouth positions. In an embodiment, the amplitudes are stored in an array or other data structure. In the example of an array, each entry of the array can correspond to a different time interval of the song. For instance, the array may have one entry for every 60^{th} of a second of the song, where the entries are ordered by time. Each of a sequence of entries in the array may indicate to a range of amplitude into which a corresponding audio of the barking track falls. In other words, entries in the array have values that correspond to respective amplitudes of barks in the barking melody and respective times.

The video can be created in various ways from such an array and tracks in various embodiments. In one embodiment, the client or server combines the barking melody with the barking track and other tracks that are used (e.g., harmony), if any, to create a recording of one or more dogs “singing” the song of the backing track. The combined audio file can be sent to another device for playback if it does not already have the file. During playback, in an embodiment, the device playing the audio morphs the image of the dog (or other object) according to key points that are set, such as described elsewhere herein and in time in the song. In one example, for the n^{th} fraction of a second (e.g., 60^{th} of a second) of the song, n being a positive integer, the device checks the location of the playhead and uses that location to determine the index to use in the array of mouth positions. If the playhead is at the n^{th} fraction of a second, the device obtains the n^{th} element in the array and uses the information to morph the image an amount corresponding to the value obtained from the array. In an embodiment, the dog image is stored as a texture on a 3d mesh and deformed using fragment shaders. Also, in an embodiment, the application playing the video exposes a function that accepts a float value from the array indicating to how open the mouth should be and deforms the texture accordingly. Playback can be timed using javascript timing events (or another such mechanism) and audio can be played back with different generic audio playback libraries, which may differ depending on whether the electronic greeting card is viewed on a web application or a mobile application or otherwise.

Other variations are also considered as being within the scope of the present disclosure. For example, instead of determining how to animate the image during playback, the animation can be pre-generated, which can involve generating frames for a video and combining by encoding in a suitable format, such as .mp4. In such an embodiment, a device can use a video player application to play the video inside of the electronic greeting card. Other options include different user interface options to be integrated with the video. For instance, in some embodiments, a user interface can allow a user to select lips for the dog and the lips can move in accordance with the mouth movements, such as described above. An interface to selects lips may occur after a user sets key points, such as described above. FIG. 15B shows an example page from an interface that allows a user to set lips for a dog. While FIG. 15B shows a dog different from the dog shown in FIG. 15A, the interface 15B, in an embodiment, shows the same dog as for which the electronic card is being created. Options in 15B that a user may select include settings that specify the color of the mouth, the thickness of the lips, and the color of the lips. Each option may provide from a limited number of selections (e.g., selectable via slider or other UI mechanism). As shown in FIG. 15B, the lips shown in the UI may be presented and modified as the user updates the settings via the controls (e.g., sliders) in the interface. Other items may be overlaid on top of the image, such as clothing items (ties, hats, jewelry) and such items can also move with movements of the dog.

In an embodiment, the graphical user interface presents the user with a selection of art frames, all of which are stored on the local storage, to border the image of the pet. The user inputs a preference for the art border and upon accepting the visuals, proceeds to the next user experience element. In an example of this embodiment, the device prompts the user for input to save the composition of the dog greeting card.

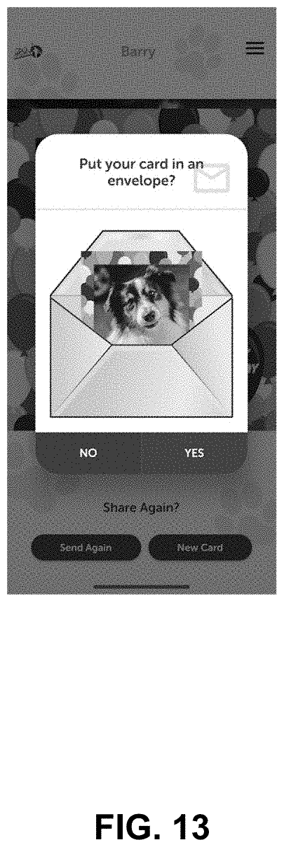

As illustrated in FIG. 13, the graphical user interface can include functionality to allow a user to select whether to put the electronic greeting card in an envelope which, in an embodiment, is additional animation to give the impression that the electronic greeting card comes forth from an actual envelope. In this example, the device running the graphical user interface can prompt the user for input to integrate the greeting card with a digital envelope. The client application takes the user input and accordingly adds, using instructions stored in the local processing system, a set of user interface components that embellish the completed composition of the dog audio recording, the image of the dog with the facial expressions, the backing track with melody adapted for dog singing notes, and the art frame.

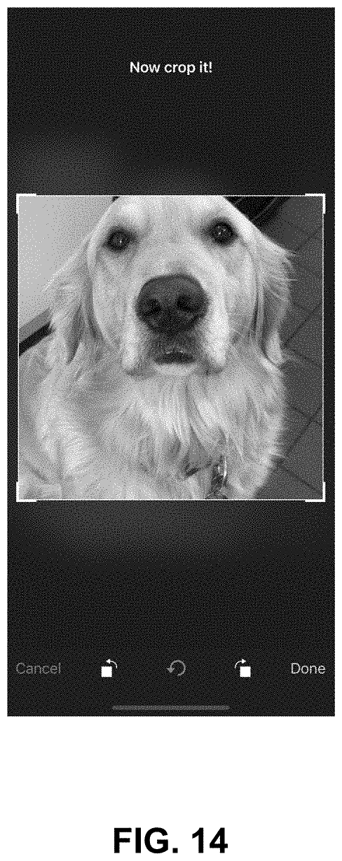

In the example pages of a graphical user interface discussed above, the examples relate to user-selection of a stock dog photo for creation of an electronic greeting card. In an embodiment, the same or similar pages can occur when the user provides (e.g., via device camera or local data store) a picture of its own dog. Additional pages can also be provided when the user provides its own image of a dog. FIG. 14, for example, shows a page that might be displayed by the graphical user interface in response to obtaining an image of a dog from a user. In this example, the user is allowed to crop the image to focus on its dog and cut out background objects as described.

Additionally, in an embodiment, when a user provides an image of its dog, a page of a graphical user interface such as illustrated in FIG. 15 can be provided. FIG. 15 shows two example interface pages. For instance, the page shown in FIG. 15A can appear after the user selects “done” in the page of FIG. 14. As illustrated in FIG. 15A, a page of the graphical user interface can enable a user to set key points of an image to enable the key points to be used as parameters in warping algorithms to cause the image to become animated. Note that key points may be set by default for stock images, but in various embodiments, the user can adjust key points of stock images to personalize how the dog appears when animated (e.g., by enlarging or making small the mouth area of the dog). In the example shown in FIG. 15A, the graphical user interface may overlay an ellipse with four key points, one corresponding to the dog's right ear, one corresponding to the dog's left ear, one corresponding to the bottom of the dog's chin, and one corresponding to the top of the dog's head.

For example, a user can, through a touchscreen interface or other device, drag the key point of the left ear to the dog's left ear, can drag the key point of the right ear to the dog's right ear, drag the lowest key point of the ellipse to the bottom of the dog's chin, and drag the top key point to the top of the dog's head. As the user drags key points into position, the ellipse can resize accordingly.

Other key points illustrated in FIG. 15A include a key point for a left eye and a key point for a right eye. In an embodiment, the key points for the eyes can be individually positioned above the eyes of the dog in the image. In some embodiments, the key points for the eyes have circles, ellipses or other shapes that can be resized to encompass the actual eyes, which may vary depending on breed and the amount of space in the image the dog's face takes.

As illustrated in FIG. 15A, the key points may include three key points for the mouth of the dog. In this example, the three key points are connected by an arc. The key points shown in FIG. 15 include a key point for the left side of the dog's mouth, the right side of the dog's mouth, and the center of the dog's mouth. As with other key points, the key points for the dog's mouth are individually able to be positioned by the user in the graphical user interface, in an embodiment.

It should be noted that the key points illustrated in FIG. 15A are provided for the purpose of illustration and other ways of determining key locations in the image of the dog are considered as being within the scope of the present disclosure. For example, fewer key points than shown can be used, additional key points can be used, and other variations are considered as being within the scope of the present disclosure. In addition, different ways of determining key points can be used. For instance, a convolutional or other neural network (e.g., running on the client device or server) can be used to detect features of the dog automatically. In some examples, automatically detected features can be provided to the user for adjustment.

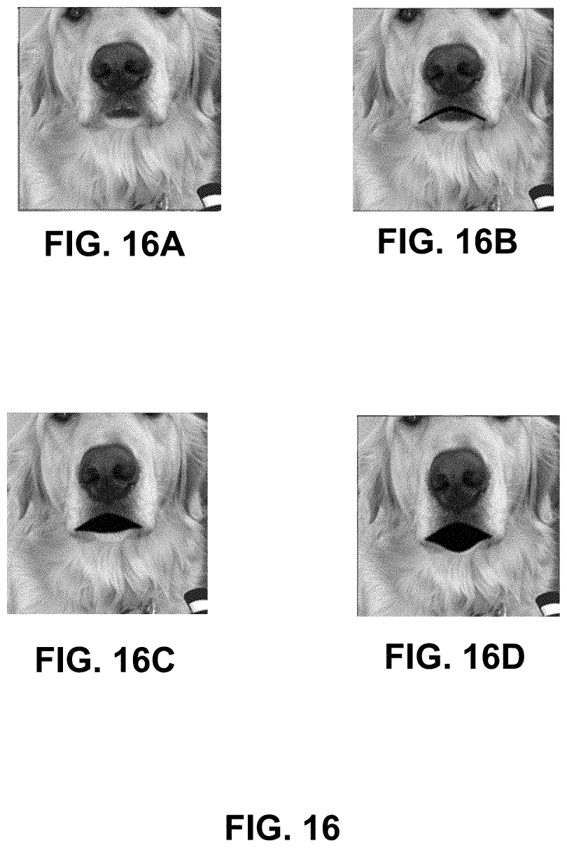

As noted above, the key points of an image can be used to animate the image. In one example, the key points are used to indicate where morphing of the image is to occur. FIG. 16 shows a series of screenshots illustrating how key points of a mount can be used to make the dog's mouth appear to be moving. FIG. 16, in particular, illustrates screenshots of a video obtained when viewing the electronic greeting card created using the key points shown in FIG. 15. As shown in FIG. 16, FIG. 16A shows the dog with its mouth closed. FIG. 16B shows the dog with its mouth slightly open. FIG. 16C shows the dog with its mouth even more open, and FIG. 16D shows the dog with its mouth wide open. In a video, there may be even more states of the mouth than shown in the figure, depending on the speed of the video playback and the length of the note the dog is singing at the same time in the electronic greeting card. As noted above, in one embodiment, sixty different mouth positions are used and/or available for use.

To create this effect, the key points of the mouth are used (e.g., by client or server, depending on which device is creating the video) to determine the width and height of an overlay of the inside of the mouth (shown as filled in with all black in the image, but may include additional detail, such as realistic or comic teeth). An animation of the mouth with those dimensions is created, where the animation comprises a series of frames from closed to wide open and back, gradually increasing and then decreasing the mouth opening. Each frame of the mouth is overlaid according to key point locations specified for the dog's face and the dog's face around the overlaid frame of the dog's mouth is morphed to accommodate, thereby appearing as if the dog's face is changing form as the mouth opens. For each note of the song, the mouth can transition from closed to open and back to closed according to the length of the note being sung. The beginning of the frames of the mouth opening and closing can be temporally aligned with the note of the song so that the dog opens and closes its mouth in the video to “sing” the song.

During the song and before and after play, other key points can be used to make the dog appear more animate. For example, warping can be used to make the dog's ears move from time to time. Similarly, the key points for the eyes can be used to morph the dog's eyes from open to closed and to achieve other effects (e.g., an overlaid pupil moving in each eye to give the impression the dog is changing the direction of gaze). Other effects are also considered as within the scope of the present disclosure.

Other techniques can be used to animate the dog in the song. For instance, a deep neural network (e.g., a generator network trained to create animations from still images of dogs) can be used to convert a still image of a dog into a clip of a dog opening and closing its mouth, which can then be used to stitch together videos to form the video for the electronic greeting card.

Further, while techniques described above relate to modulating the bark of a dog to match various pitches in a song, in alternative embodiments, pitches of a song are modulated so that a note in the song (e.g., the note closest to the mean or median pitch of the song) is modulated to match the bark of the dog, thereby allowing the bark to be completely natural sounding for that note. By mean and median, various calculations can be used. For example, the mean can be calculated as a straight mean or median of the pitches that occur in the song (where each pitch counts once in the average) or by allowing treating each note in the song as a separate input into the function that computes the mean or median. In some examples, a weighted average is used where notes marked as more important (e.g., a final note) are given higher weight.

As another example, instead of converting a still image of a dog into a video of the dog singing, alternative embodiments allow a user to upload a video of the dog barking and the video can be edited (e.g., time synchronized) so that each bark occurs in time with corresponding notes of a selected song. Additionally, as noted, different embodiments can use other objects, such as cats, other pets, inanimate objects, and the like. Alternative sounds can also be used. For instance, in one embodiment, a user can upload a picture of a front of a car and audio of the car's horn. Key points can be selected on the car to enable the video to be created where the car mimics the face of a human (e.g., the grill operates as the mouth, the headlights are eyes, the rear view mirrors are ears, etc.). Generally, it should be noted that the embodiments described herein are illustrative in nature and one with ordinary skill in the art will appreciate variations that are within the scope of the present disclosure. FIG. 17 is an illustrative, simplified block diagram of a computing device 1700 that can be used to practice at least one embodiment of the present disclosure. In various embodiments, the computing device 1700 includes any appropriate device operable to send and/or receive requests, messages, or information over an appropriate network and convey information back to a user of the device. The computing device 1700 may be used to implement any of the systems illustrated and described above. For example, the computing device 1700 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 1700 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 17, the computing device 1700 may include one or more processors 1702 that communicate with and are operatively coupled to a number of peripheral subsystems via a bus subsystem. In some embodiments, these peripheral subsystems include a storage subsystem 1706, comprising a memory subsystem 1708 and a file/disk storage subsystem 1710, one or more user interface input devices 1712, one or more user interface output devices 1714, and a network interface subsystem 1716. Such storage subsystem 1706 may be used for temporary or long-term storage of information.

In some embodiments, the bus subsystem 1704 may provide a mechanism for enabling the various components and subsystems of computing device 1700 to communicate with each other as intended. Although the bus subsystem 1704 is shown schematically as a single bus, alternative embodiments of the bus subsystem utilize multiple buses. The network interface subsystem 1716 may provide an interface to other computing devices and networks. The network interface subsystem 1716 may serve as an interface for receiving data from and transmitting data to other systems from the computing device 1700. In some embodiments, the bus subsystem 1704 is utilized for communicating data such as details, search terms, and so on. The network interface subsystem 1716 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UPnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 1716 is enabled by wired and/or wireless connections and combinations thereof.

In some embodiments, the user interface input devices 1712 include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 1700. In some embodiments, the one or more user interface output devices 1714 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 1700. The one or more user interface output devices 1714 can be used, for example, to present user interfaces to facilitate user interaction with software applications performing processes described and variations therein, when such interaction may be appropriate.

In some embodiments, the storage subsystem 1706 provides a computer-readable storage medium for storing the basic programming and data constructs that provide the functionality of at least one embodiment of the present disclosure. The software applications (programs, source code modules, instructions), when executed by one or more processors in some embodiments, provide the functionality of one or more embodiments of the present disclosure and, in embodiments, are stored in the storage subsystem 1706. These software application modules or instructions can be executed by the one or more processors 1702. In various embodiments, the storage subsystem 1706 additionally provides a repository for storing data used in accordance with the present disclosure. In some embodiments, the storage subsystem 1706 comprises a memory subsystem 1708 and a file/disk storage subsystem 1710.

In embodiments, the memory subsystem 1708 includes a number of memories, such as a main random access memory (RAM) 1718 for storage of instructions and data during program execution and/or a read only memory (ROM) 1720, in which fixed instructions can be stored. In some embodiments, the file/disk storage subsystem 1710 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 1700 includes at least one local clock 1724. The at least one local clock 1724, in some embodiments, is a counter that represents the number of ticks that have transpired from a particular starting date and, in some embodiments, is located integrally within the computing device 1700. In various embodiments, the at least one local clock 1724 is used to synchronize data transfers in the processors for the computing device 1700 and the subsystems included therein at specific clock pulses and can be used to coordinate synchronous operations between the computing device 1700 and other systems in a data center. In another embodiment, the local clock is a programmable interval timer.

The computing device 1700 could be of any of a variety of types, including a portable computer device, tablet computer, a workstation, or any other device described below. Additionally, the computing device 1700 can include another device that, in some embodiments, can be connected to the computing device 1700 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 1700 for processing. Due to the ever-changing nature of computers and networks, the description of the computing device 1700 depicted in FIG. 17 is intended only as a specific example for purposes of illustrating the preferred embodiment of the device. Many other configurations having more or fewer components than the system depicted in FIG. 17 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 1700 may include any appropriate hardware, software and firmware for integrating with a data store as needed to execute aspects of one or more software applications for the computing device 1700 to handle some or all of the data access and business logic for the one or more software applications. The data store, in an embodiment, includes several separate data tables, databases, data documents, dynamic data storage schemes, and/or other data storage mechanisms and media for storing data relating to a particular aspect of the present disclosure. In an embodiment, the computing device 1700 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 1700 may provide access to content including, but not limited to, text, graphics, audio, video, and/or other content that is provided to a user in the form of HTML, XML, JavaScript, CSS, JavaScript Object Notation (JSON), and/or another appropriate language. The computing device 1700 may provide the content in one or more forms including, but not limited to, forms that are perceptible to the user audibly, visually, and/or through other senses. The handling of requests and responses, as well as the delivery of content, in an embodiment, is handled by the computing device 1700 using PHP: Hypertext Preprocessor (PHP), Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 1700 typically will include an operating system that provides executable program instructions for the general administration and operation of the computing device 1700 and includes a computer-readable storage medium (e.g., a hard disk, random access memory (RAM), read only memory (ROM), etc.) storing instructions that if executed (e.g., as a result of being executed) by a processor of the computing device 1700 cause or otherwise allow the computing device 1700 to perform its intended functions (e.g., the functions are performed as a result of one or more processors of the computing device 1700 executing instructions stored on a computer-readable storage medium).

In an embodiment, the computing device 1700 operates as a web server that runs one or more of a variety of server or mid-tier software applications, including Hypertext Transfer Protocol (HTTP) servers, FTP servers, Common Gateway Interface (CGI) servers, data servers, Java servers, Apache servers, and business application servers. In an embodiment, computing device 1700 is also capable of executing programs or scripts in response to requests from user devices, such as by executing one or more web applications that are implemented as one or more scripts or programs written in any programming language, such as Java®, C, C #, or C++, or any scripting language, such as Ruby, PHP, Perl, Python, or TCL, as well as combinations thereof. In an embodiment, the computing device 1700 is capable of storing, retrieving, and accessing structured or unstructured data. In an embodiment, computing device 1700 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more software applications) executing collectively on one or more processors, by hardware, or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method, comprising:
obtaining an image depicting an object;
obtaining an audio track comprising one or more musical notes;
segmenting an audio clip into a first set of one or more audio segments;
modulating the first set of one or more audio segments by adjusting the first set of one or more audio segments to match the one or more musical notes of the audio track;
generating a second set of one or more audio segments based, at least in part, on the modulation;
generating a second audio track by combining the second set of the one or more audio segments and the audio track; and
generating a video comprising one or more animations of the object and associating the second audio track with the one or more animations.

2. The computer-implemented method of claim 1, further comprising:
adjusting the first set of one or more audio segments by at least changing one or more pitches of the first set of one or more audio segments to match the one or more musical notes.

3. The computer-implemented method of claim 1, wherein the audio track is a song.

4. The computer-implemented method of claim 1, further comprising:
generating a digital greeting card comprising at least the video and the second audio track.

5. The computer-implemented method of claim 1, wherein the object is an animal.

6. The computer-implemented method of claim 1, further comprising:
using one or more neural networks to determine one or more features of the object; and
generating the one or more animations based, at least in part, on the one or more features.

7. A system, comprising:
one or more processors; and
memory with instructions that, as a result of being executed by the one or more processors, cause the system to:
obtain an image depicting an object;
obtain an audio track and an audio clip;
modulate a first set of audio segments of the audio clip based, at least in part, on a set of musical notes of the audio track to generate a second set of audio segments;
generate a second audio track based, at least in part, on the audio track and the second set of audio segments; and
generate a video comprising the second audio track and depicting one or more animations of the object.

8. The system of claim 7, wherein the instructions further include instructions, which if performed by the one or more processors, cause the system to at least:
associate one or more audio segments of the second set of audio segments with one or more musical notes of the set of musical notes.

9. The system of claim 7, wherein the instructions further include instructions, which if performed by the one or more processors, cause the system to at least:
provide the audio clip to one or more servers; and
obtain one or more indications from the one or more servers that indicate the first set of audio segments.

10. The system of claim 7, wherein the one or more animations include one or more features of the object animated based, at least in part, on a melody of the audio track.

11. The system of claim 7, wherein the instructions further include instructions, which if performed by the one or more processors, cause the system to at least:
identify one or more features of the object based, at least in part, on input from one or more users; and
generate the one or more animations based, at least in part, on the one or more features.

12. The system of claim 7, wherein the object is an automobile.

13. A non-transitory computer-readable storage medium comprising executable instructions that, as a result of being executed by one or more processors of a computer system, cause the computer system to at least:
obtain an image depicting an object with one or more features;
obtain an audio clip and an audio track comprising one or more musical notes;
modulate one or more audio segments of the audio clip to match the one or more musical notes of the audio track;
generate one or more modulated audio segments based, at least in part, on the modulation;
generate a second audio track based, at least in part, on the one or more modulated audio segments and the audio track; and
generate a video associating the second audio track with one or more animations of the object.

14. The non-transitory computer-readable storage medium of claim 13, wherein the executable instructions further include instructions that, as a result of being executed by the one or more processors of the computer system, cause the computer system to at least:
generate an animated image to depict the one or more animations of the object based, at least in part, on the one or more features of the object and the audio track; and
generate the video to comprise at least the animated image.

15. The non-transitory computer-readable storage medium of claim 13, wherein the executable instructions further include instructions that, as a result of being executed by the one or more processors of the computer system, cause the computer system to at least modulate the one or more audio segments by at least mapping the one or more audio segments to the one or more musical notes.

16. The non-transitory computer-readable storage medium of claim 13, wherein the executable instructions further include instructions that, as a result of being executed by the one or more processors of the computer system, cause the computer system to at least determine the one or more features based, at least in part, on input from one or more users in connection with a graphical user interface.

17. The non-transitory computer-readable storage medium of claim 13, wherein the executable instructions further include instructions that, as a result of being executed by the one or more processors of the computer system, cause the computer system to at least use one or more neural networks to generate the video.

18. The non-transitory computer-readable storage medium of claim 13, wherein:
the audio clip includes one or more barking sounds of a dog; and
the one or more audio segments of the audio clip correspond to the one or more barking sounds.

19. The non-transitory computer-readable storage medium of claim 13, wherein the executable instructions further include instructions that, as a result of being executed by the one or more processors of the computer system, cause the computer system to at least use one or more pitch detection algorithms to map the one or more audio segments to the one or more musical notes.

20. The non-transitory computer-readable storage medium of claim 13, wherein the executable instructions further include instructions that, as a result of being executed by the one or more processors of the computer system, cause the computer system to at least obtain the audio clip from local data storage associated with one or more users.
